(19) United States
(12) Patent Application Publication
(10) Pub. No.: US 2016/0077013 A1
(43) Pub. Date: Mar. 17, 2016

(54) Laminated Detector for Detection and Quantitative Determination of Formaldehyde

(71) Applicants: Amir James Attar, Raleigh, NC (US); Matthew David Swartz, Raleigh, NC (US); Jason Allen Morton, Raleigh, NC (US)

(72) Inventors: Amir James Attar, Raleigh, NC (US); Matthew David Swartz, Raleigh, NC (US); Jason Allen Morton, Raleigh, NC (US)

(21) Appl. No.: 14/059,041

(22) Filed: Oct. 21, 2013

(51) Int. Cl. G01N 21/78; G01N 31/22

(52) U.S. Cl. CPC G01N 21/78; G01N 31/22; G01N 2021/7759

(57) ABSTRACT

A multi-layered laminated test strip detector for formaldehyde is described which simplifies significantly the qualitative detection and quantitative determination of formaldehyde in aqueous solution or on the surface of wet solids. Layers of water soluble polymer are used to separate chemical reagents that otherwise will not be stable, and/or encapsulate the chemical reagents on bibulous material. Introducing the sample or wetting the detector through holes in a laminated encapsulating envelope permits the aqueous sample to dissolve the solid barrier when the sample is introduced and contact the reagents and the analyte, thereby forming color on the back side of the detector.

### BACKGROUND OF THE INVENTION

1. Field of Invention

This invention describes a dry-chemistry-based detector for detecting or determining aldehydes, in particular formaldehyde, in aqueous solutions and in wet solid surfaces such as thawed fish, shrimp, etc. This technology allows rapid detection and/or determination of the formaldehyde in a sample without the user having to prepare calibrated solutions, mix them or use spectrometers or chromatographs in the analytical process. The invention uses novel dry chemistry methods of known spectrometric methods for the analysis of aldehydes, mainly formaldehyde, and discloses a modified and improved method.

2. Background of the Invention

Formaldehyde is present in many biological systems and small amounts are present in many products, including some foods. Very large quantities of formaldehyde are produced annually and are used in a variety of applications and products. The main applications include sterilization, disinfection, fixation of tissues and embalming. Formaldehyde is used to make many polymers such as phenol formaldehyde and urea formaldehyde, which are used in very common products such as automobiles, carpets, drapes, thermal insulation, polymers finishes for cars, explosives, adhesives, certain paints, floors, air filters, shampoos and countless other products and packaging. As a consequence, people are continually being exposed to small amounts of formaldehyde while breathing or eating at home and in the work place.

Formaldehyde reacts with amino groups, including amino groups in amino acids and proteins. Therefore, it is toxic to human, animals and bacteria. This is why formaldehyde has been used for years to preserve tissues and to disinfect areas for sanitary purposes. The Occupational Safety and Health Administration, OSHA, and the Environmental Protection Agency, EPA, set very low limits on the amount of formaldehyde that a person is allowed to breathe in both occupational and residential settings. The FDA forbids adding any amount of formaldehyde to food, but allows using very small amounts in applications such as sterilizing fish eggs. The EPA as well as many other institutions regard formaldehyde as a human carcinogen.

Since formaldehyde is ubiquitous in many biological systems, every person is exposed all the time to small amounts of formaldehyde. However, the effect of small exposure is not immediately visible and therefore the toxicity of formaldehyde is often disregarded. But, the toxicity is real never the less. We should distinguish between acute toxicity, which effects are seen in a short time, and chronic toxicity, which effects are seen only months down the road. The acute sensitivity of people to formaldehyde varies widely. The most common effects of acute formaldehyde exposure on adults are nasal problems, breathing problems, and tearing of the eyes. Some people are very sensitive and others are much less sensitive. Chronic and acute exposure to formaldehyde reduces the body's ability to fight diseases and thus the effect of exposure to formaldehyde may be seen as frequent contraction of diseases. Research was published that implicated formaldehyde exposure in early stages of pregnancy with mutations of the fetus and post-natal cognitive problems.

Although the FDA forbids adding formaldehyde to food and drinks, it is an established fact that adding formaldehyde to fish, shrimp, fruits, vegetables and milk extends their shelf life and reduces their rate of spoilage. Despite the fact that adding formaldehyde to food is forbidden by law in all countries, many merchants add formaldehyde to fish, shrimp, meats, milk and fruits and vegetables to extend their shelve life. This practice is very prevalent in countries where refrigerated storage is not very available including Bangladesh, India, China, Indonesia, Pakistan, Afghanistan and Malaysia.

Since formaldehyde is very toxic, and because it is added by some merchants to food, there is a compelling need for simple analytical methods that allow detecting formaldehyde in food instantly and at the point of consumption. More specifically, there is a need to have low-cost methods that can be used even by a layman, in the field or home, that indicate the presence of formaldehyde instantly and on the spot. Many analytical methods have been developed for formaldehyde but unfortunately, all the available methods require laboratory instruments and trained personnel to conduct them. Moreover, the results are obtained in two hours to several days, depending on the instrumentation used, the availability of calibration curves, etc. This invention presents several dry-chemistry-based, low-cost detectors for aliphatic aldehydes, notably for formaldehyde, that can be readily used even by untrained personnel and which detect formaldehyde essentially instantly, simply by looking on a color change in the detection tab. Moreover, a special embodiment of the detectors of this invention is described, which can be used to test the surface of foods such as those of thawed fish and shrimp to determine instantly if formaldehyde is present in them. Some embodiments of this invention allow a user to conduct a quantitative measurement of the amount of formaldehyde in the sample without the need to dilute the sample, mix reagents, etc.

The method of this invention can be easily applied to the detection of all aldehydes including, for example, glutaraldehyde and acetaldehyde. The term formaldehyde is used generically to denote all aliphatic aldehydes.

### PRIOR ART

Since the economic importance of formaldehyde is extremely high, significant effort was invested in finding methods and technology to determine the concentration of formaldehyde in air, water and food. Various chemistries have been advanced for the determination of formaldehyde in aqueous solutions. The methods that are used most frequently today involve using a chromogenic reagent that forms a color when it reacts with aldehyde, notably with formaldehyde, and measuring the color formed spectrometrically. Many other methods are used which involve gas chromatography and liquid chromatography. The various methods were reviewed by Sawicki, E. and Sawicki, C. R. The Center for Disease Control, CDC, and NIOSH published a review (Available on the Internet), of methods for the analysis of formaldehyde in liquid samples based on gas chromatography, liquid chromatography and spectrometry. Method 3500 refers to the spectrometric analysis of formaldehyde that was absorbed from air in water using chromotropic acid. The Food and Drug Administration, the FDA, published a list of the methods for analysis of formaldehyde, mainly by chromatography. Grosjean and Fung (as well as many others), describe the classical use of 2,4-dinitro phenyl hydrazine to form color with aliphatic aldehydes. The color formed is in the wavelength range of 427-428 nm is barely visible when the aldehyde detected is formaldehyde. Zurek and Karst, and Hauser and Cummings are some of the many researchers who described the use of 3-methyl-2-benzothiazolinone, (MBTH), in the spectrometric analysis of formaldehyde. The detection results in a vibrant turquoise-blue color. Jacobsen and Dickenson, and Hobbs, H. B., published two of the many studies on the use of the chromophore 4-Amino-3-hydrazino-5-mercapto-1,2,4-triazole, 4-Amino-5-hydrazino-1,2,4-triazole-3-thiol, also known as Purpald® to detect formaldehyde spectrometrically in solution. The analysis requires the use of an oxidizer. Persulfates and periodates are the oxidizers used (Avigard G.). Other chromogenic materials have been used to analyze formaldehyde in solutions including chromotropic acid, rubeanic acid and others.

Dry chemistry type detectors have been developed for various gases including formaldehyde. Attar U.S. Pat. No. 4,666,859 teaches how to make a dosimeter for gaseous formaldehyde using dry chemistry. In U.S. Pat. No. 4,511,658 Chiang and Lambert teach how to use 4-amino-3-hydrazino-5-mercapto-1,2,4-triazole (AHMT) supported on sodium bicarbonate to detect formaldehyde in the gas phase. Nakano Et. al. U.S. Pat. No. 7,101,716 teaches how to use 4-amino-4-phenyl-3-ene-2-one to detect formaldehyde in the gas phase.

Houghton, R. (2008) reviewed the state of the art technology and the detectors available for detecting materials in solution using detectors consisting of a paper, often adhered onto a handle, which changes its color when dipped into the solution. The paper is impregnated or coated with a reagent that reacts with an ingredient of the solution. Such tabs produce color on the front side, which indicates qualitatively if a particular material is present in the liquid sample. A semi-quantitative estimation of the detected material is sometimes possible by comparing the color formed to a printed color chart. These tabs consist of a single coated sheet of paper adhered to a handle. The application of tabs to determine the pH, alkalinity, chloride content, etc. in water or urine is the basis for many products. However, the basis of all these products is a reaction that takes place in a single layer.

Attar in U.S. Pat. No. 4,772,560 used a membrane to limit the rate of sample intake to the rate of diffusion through the membrane regardless of the air velocity. He used the fact that the rate of transport of toxic materials from moving air onto a bibulous material coated or impregnated with a chromogenic material to obtain a quantitative dosimeter. The membrane also separates the chromogenic material from direct contact with the air. He also demonstrated the use of screening materials coated on the diffusion membrane to remove interfering impurities from the air, which could affect the chromogen. Gross and Gross in U.S. Pat. No. 4,478,944 teach the use of a distribution layer and of cells-impermeable barrier to separate blood components and yet allow the analyte, glucose, to diffuse through into a reagent layer and form color. Boone Et. Al, U.S. Pat. No. 8,343,726, used a passive diffusion membrane to separate the liquid test sample from the specific biological binding reagents. Appealing Products Inc. has been marketing since 2004 detectors for solid traces of explosives or explosives in solution. Several layers of bibulous material were impregnated with reagents and the wetting of the detector by the aqueous solution permitted the reagents from the multiple layers and the explosives to interact with each other and form color. The reagents were not embedded or encapsulated in protective layers as a barrier. Traces of ammonium nitrate, urea nitrate and gun powder residues can be easily detected.

Attar teaches in U.S. Pat. No. 4,772,560 that a transparent laminating material can be used to enclose together several and that the color formed due to the detection of gases can be viewed from the back side. Nygaard, U.S. Pat. No. 8,460,863 describes a dry stick with several glued layers for detecting urea in milk and for other materials. The stick contains at least two pads glued together with two different reagents. The color formed due to the detection of urea is viewed from the front. Mihaylov et. al in U.S. Pat. No. 5,364,593 described a discrete color changing dosimeter for gases.

Appealing Products Inc. has been marketing since 2004 detection tabs for explosive materials and gun-shot residue consisting of several parallel layers. The detector for ammonium nitrate uses several reagent-containing layers. The ammonium nitrate detector is marketed under the name “On the Spot” and consists of two pads with reagent in close contact with each other. Each of the two pads consists of bibuluous material impregnated with a different reagent. This detectors are used to test solutions for the presence of ammonium nitrate and other explosives, since the water in the test solution allow mixing the reagents impregnated on the different pieces of bibulous support with the sample material. Solid samples can be tested by placing water or solvent on them. The water or solvent dissolves the material tested and the impregnated reagents and subsequently produces color change.

Since the stability of the chemistry inside the detector is a very critical commercial attribute, the detectors in the market use a single chromogenic chemical, or a mixture of chromogenic materials that do not react with each other. The instability of certain reagents, when they are present together, has prevented the conversion of many analytical methods into the more economical and convenient dry-chemistry format. This requirement is critical to afford the detector a practical shelf life. Thus, no detectors that involve reagents that could react with each other have been converted into a detection tab/stick. Encapsulating some of the reagents in a barrier matrix as well as putting different reagents in different layers of support increases the stability of the detector:

The detection tabs are stored often in an envelope, or a vial, with a color chart printed on it, that allow the user to compare the color formed and estimate the magnitude or concentration of the analyte in the solution.

### SUMMARY OF THE INVENTION

This invention is embodied in placing up to five layers of materials in close contact with each other, within a laminated envelope. The envelope keeps the layers together, in a predetermined orientation relative to each other and relative to liquid entry ports and viewing areas in the laminating envelope. The number of layers depends on the particular embodiment. The envelope is made of a thin material, often made of a polymeric film, and is transparent at least on one side to allow viewing the color below.

The first layer inside the envelope is a bibulous layer added in some embodiments to help distribute and disseminate the sample inside the detector. The second layer is a bibulous material impregnated or coated with a catalyst or with a base encapsulated in a water-soluble polymer. The third bibulous layer is impregnated with a water-soluble oxidizer. The fourth layer is a bibulous material with a chromogenic reagent embedded in a polymeric matrix. A fifth layer consisting of a rigid transparent material such as a glass or a polymer is added in some embodiments to permit more accurate electronic reading of the color formed. The first and the fifth layers are optional and are used in some embodiments as needed.

When the aqueous solution enters the detector, it first wets the layer with the base or catalyst and dissolves the encapsulating polymer. The resultant solution enters then into the oxidizer layer and dissolves the oxidizer and then transports the alkaline oxidizer solution into the chromogenic layer. If formaldehyde is present in the sample, a color forms which indicates the presence of formaldehyde in the original sample. The color intensity is quantitatively related to the concentration of formaldehyde in the original sample. Therefore, the formaldehyde concentration may be estimated by electronic color measurement or by comparing the intensity of the color formed to the colors on a printed color chart.

The same principles and similar internal structures are used in this invention to make different embodiments of detectors for formaldehyde. Four embodiments are described in detail. Many others can be made to meet other applications by people skilled in the art. Each embodiment described is more suited for use in different applications, as described below. The embodiments can be varied based on the relative locations of the sample entry ports, to the dry-chemistry-based detector and in the presence of an observation window for electronic reading of the color formed. The three different structures address different ways to use the detectors: testing the surface of food such as fish is done using the swab format, testing a solution is done using the dipstick format, and quantitative testing of the concentration of formaldehyde in solution is done using a card format. The forth structure is a variant on the embodiment which permits more accurate quantitative analysis of the solution since it contains a built-in reference site on the detector.

Different colorimetric chemistries can be used alternatively in the same embodiment. Three alternative reagents combinations are described in this invention but others may be similarly adopted by people skilled in the art. All the methods are dry chemistry based. Two of them are adaptations of established and published spectrometric wet chemistry analytical methods and the third method uses a novel chemistry developed specifically in this invention and involves an improved version of one of the previously mentioned methods. The new method may be used both in solution as well as a dry chemistry method.

The three chemistries that were adapted to dry chemistry format and are described in detail in this invention are:
1. The method which uses 4-Amino-3-hydrazino-5-mercapto-1,2,4-triazole, as the chromogenic reagent. The use of 4-Amino-3-hydrazino-5-mercapto-1,2,4-triazole, to detect and determine formaldehyde in solutions has been described in the literature by Hopes and by Avigard, but no technology was presented where 4-Amino-3-hydrazino-5-mercapto-1,2,4-triazole, was used in dry chemistry. Carico described in U.S. Pat. No. 6,426,182 and Opp in U.S. Pat. No. 4,471,055 described kits where 4-Amino-3-hydrazino-5-mercapto-1,2,4-triazole, was used to determine if the concentration of formaldehyde or glutaraldehyde in a solution that exceeds certain threshold. (Denoted hereafter Chemistry A).
2. A novel method which uses a derivative of 4-Amino-3-hydrazino-5-mercapto-1,2,4-triazole, to detect aldehydes such as formaldehyde in solution or in the surface of a solid. The chemistry of this method is one of the subjects of this invention. This chemistry is useable in solution as well as in the form of dry chemistry. The essence of this method is to use a metal salt of 4-Amino-3-hydrazino-5-mercapto-1,2,4-triazole, as the chromophore. Typical usable metal salts include salts of thallium, mercury, cadmium, zinc, manganese and others. In the preferred embodiments zinc is used as the metal. (Denoted hereafter Chemistry B).
3. The method which uses 3-methyl-2-benzothiazolinone hydrazone hydrochloride (MBTH) as a chromogene for detecting aldehydes, notably formaldehyde. The chemistry of this chromophoric reagent was described in Zurek and Karst, and, Hauser and Cummings in U.S. Pat. No. 3,645,696. Iannacone and Revukas describe how to prepare a stable detector containing MBTH and how to use it to detect ethylene glycol in motor oil. Lin and Zhu describe in U.S. Pat. No. 7,112,448 a method for detecting if the formaldehyde concentration in a solution exceeds certain value. (Denoted hereafter Chemistry C).

The use of metal-4-Amino-3-hydrazino-5-mercapto-1,2,4-triazole, compounds as the chromophore was not reported previously in the literature or in any patent. Such use is a part of this invention. Table #1 describes the various layers in each type of chemistry.

Each support layer may be made of the same materials or from different materials than any of the other layers. The support materials that can be used in this invention include, but are not limited to, paper, blotting paper, cotton fabric, polymeric membranes such as nylon, cellulose nitrate, cellulose, fluoro-polymers, polystyrene, etc. polymer sheets, metallic films, porous metallic films, porous ceramic films or sheets, porous solid particles adhered onto a polymeric film, e.g. silica, alumina, thoria, iron oxides, lanthanum oxide, zirconium oxide or other solids adhered onto glass or a polymeric film such as polyester film in the form of TLC plates, or onto a membrane. Sized support material may be used to control the thickness and permeability of the support layer. Different materials, such as polymers, may be used to coat the support at different thicknesses.

TABLE #1
Chemistry and Structures of the Dry Chemistry Formaldehyde Detector.

| Chemistry | Purpald ® #1 | Purpald ® Metal #2 | MBTH #3 |
|---|---|---|---|
| Outer capsule | Polymer film with binder¹ | Polymer film with | Polymer film with |
| | | binder¹ | binder¹ |
| Layer #1 | Distribution layer² | Distribution layer² | Distribution layer² |
| Layer #2 | Encapsulated hydroxide³ | Encapsulated hydroxide³ | Coated or encapsulated |
| | | | oxidizer or catalyst⁸ |
| Layer #3 | Oxidizer⁴ | Oxidizer⁴ | Oxidizer⁸ |
| Layer #4 | Purpald ® and Stabilizer⁵ | Purpald ®, metal⁷ and | MBTH and stabilizer⁹ |
| | | Stabilizer | |
| Layer #5 | Transparent window⁶ | Transparent window⁶ | Transparent window⁶ |
| Outer capsule | Polymer film with binder¹ | Polymer film with | Polymer film with |
| | | binder¹ | binder¹ |

Note #¹: Typically, polyester film with LMW polyethylene binder is used.
Note #²: A porous bibulous material is used here such as re-deposited paper. This layer is not used in all the embodiments.
Note #³: The best results are obtained using a strong base such as NaOH or KOH encapsulated in a polymer such as PVA or PVP and deposited on a bibulous layer such as paper.
Note #⁴: Different oxidizers may be used including persulphates, periodates, nitrates, perchlorates, chlorates, and others. Nitrates are used in the preferred embodiment.
Note #⁵: Purpald ® stabilized with BHT and embedded in a matrix of PVP or Polystyrene sulfonate is coated to form a layer 200 microns thick
Note #⁶: A thin glass or rigid polymer can be used in some embodiments to improve the quantitative electronic reading. Two polymers that give good results are polycarbonate and polymethyl metacrylate. Other polymers may be used too.
Note #⁷: The metal ions that can be used to improve the detection include metals such as copper, zinc, cobalt, nickel, chromium, thallium, mercury, lead, cadmium and others.
Note #⁸: The preferred oxidizer/catalyst for this chemistry is a salt containing trivalent iron such as ferric sulfate, potassium ferric cyanide, etc.
Note #⁹: The MBTH is used as is or placed in a polymeric matrix to protect its stability. Suitable polymers are PEO, PVP, PEG, CMC and many others.

List of Abbreviations

| | |
|---|---|
| BHT | Butylated hydroxytoluene |
| CMC | Carboxymethyl cellulose |
| LMW | Low Molecular Weight |
| MBTH | 3-Methyl-2-benzothiazolinone hydrazone |
| PEG | Poly(ethylene) glycol |
| PEO | Poly(ethylene oxide) |
| Purpald ® | 4-Amino-3-hydrazino-5-mercapto-1,2,4-triazole |

Other reagents may be used alternatively to create a dry chemistry based formaldehyde detector including but not limited to salicylalhydrazone, p-nitrobenzal hydrazone, 2-hydrazinobenzothiazole, 2 hydrazinobezothiazole-4-nitrobenzenediazonium fluoborate, and others.

The main components of the internal structures of the different embodiments of detectors are essentially the same. The main differences between the detectors are in the relative locations of the sample entry ports and the windows through which the color formed due to formaldehyde, and how it is detected qualitatively or determined quantitatively. Although specific examples are provided with specific applications, many variants of the size, structure and applications can be easily produced by a person skilled in the art. Specific examples are used only to demonstrate the principles and not to limit the scope of the invention.

The invention is embodied as a method for using the indicator to detect or determine quantitatively formaldehyde in a solution or on the surface of wet solid.

Three types of embodiments of this invention are described. They are specific examples of three types of applications of the dry chemistry detectors: A dipstick for qualitative detection and semi-quantitative determination of formaldehyde in solution, an emersion detector denoted QuantTab™, mainly for the quantitative determination of formaldehyde in solution, mainly by electronic readers, and a swab detector for qualitative and semi-quantitative assessment of formaldehyde on a wet surface by swabbing the surface of a sample that contains formaldehyde. Although specific designs are presented in the example, many variations of the principles may be used to obtain similar results. The intent of the examples is only to illustrate the principles and not to limit the scope of the invention.

### A BRIEF DESCRIPTION OF THE FIGURES

FIG. 1A shows the front side of a dip stick detector where 01 is a handle 13 is the laminated dry-chemistry layered sensing part. The color formation due to the detection of formaldehyde is seen from the other side.

FIG. 1B shows the back side of the detector where a visible color forms upon detection of formaldehyde.

FIG. 1C shows a cross section of the sensing element at A-A. The numbers in FIG. 1C corresponds to the numbers in Table #1 as follows: 04 corresponds to the outer capsule, 09 corresponds to Layer #1, 08 corresponds to Layer #2, 07 corresponds to Layer #3 and 06 corresponds to Layer #4.

FIG. 2A shows the front side of a QuantTab™ Design #1 detector where 01 consists of an assembly of layers as shown in FIG. 2C, enclosed in a laminated plastic pouch which acts also as a handle and 10 is the sample entry port. FIG. 2A shows the detector as seen from the bottom part of FIG. 2C and FIG. 2B shows it from side corresponding to the top part of FIG. 2C.

FIG. 2B shows the back side of the detector where a visible color forms upon detection of formaldehyde. The color formation due to detecting formaldehyde is seen through the detector area.

FIG. 2C shows a cross section A-A through the sensing element. The numbers in FIG. 2C corresponds to the numbers in Table #1 as follows: 04 corresponds to the outer capsule, 09 corresponds to Layer #1, 08 corresponds to Layer #2, 07 corresponds to Layer #3 and 06 corresponds to Layer #4.

FIG. 2D shows the cross section B-B through the length of the QuantTab™ detector.

FIG. 3A shows the front side of a QuantTab™ Design #2 detector where 01 consists of an assembly of layers as described below, enclosed in a laminated plastic pouch which acts also as a handle. 03 is the sample entry port in the plastic laminate through which the sample is introduced and 02 is the front side where visible color forms upon detection of formaldehyde. FIG. 3A shows the detector as seen from top part of FIG. 3C and FIG. 3B shows it from side corresponding to the bottom part of FIG. 3C.

FIG. 3B shows the back side of the detector where a sample is introduced into the detector. The color formation due to detecting formaldehyde is seen as a round spot in the area corresponding to 02.

FIG. 3C shows a cross section A-A through the sensing element. The numbers in FIG. 3C correspond to the numbers in Table #1 as follows: 04 corresponds to the outer capsule, 60 corresponds to Layer #1, 70 corresponds to Layer #2, 80 corresponds to Layer #3 and 90 corresponds to Layer #4. 50 is a rigid non-permeable transparent window which allows viewing the color formed in 90.

FIG. 3D shows the cross section B-B through the length of the QuantTab™ detector.

FIG. 4A shows the front side of a swab type detector where 01 consists of an assembly of layers as described below, enclosed in a laminated plastic pouch which acts also as a handle and 11 is an opening window through which the sample is introduced by swabbing a surface. This hole is also used to add water to develop the color. The color formation due to detecting formaldehyde is seen from the other side.

FIG. 4B shows the back side of the detector where a visible color forms upon detection of formaldehyde in zone 12.

FIG. 4C shows a cross section of the sensing element at A-A. The top side of FIG. 4C is seen in FIG. 4A and the bottom side of FIG. 4C is seen in FIG. 4B. The numbers in FIG. 4C corresponds to the numbers in Table #1 as follows: 04 corresponds to the outer capsule, 60 corresponds to Layer #1, 70 corresponds to Layer #2, 80 corresponds to Layer #3 and 90 corresponds to Layer #4.

FIG. 4D shows a cross section through the length of the swab detector at B-B where no internal layers are present.

FIG. 5A shows a QuantTab™ Style 3 formaldehyde detector with a color chart 140 printed or adhered to it for ease of color comparison. 120 is a laminated handle for ease of conducting the tests. The sample entry port is 150 and visible color forms in 130 to indicate detection.

FIG. 5B shows the back side of the detector.

FIG. 6A is a top view of one design of the insertion sleeve used with the QuantTab™ detectors to obtain a quantitative reading. The sleeve consists of two layers 36 of polymeric film laminated together in the periphery with an opening between them. This particular design includes two functional parts: a pocket 34 into which a QuantTab™ detection tab can be inserted into the pocket in the sleeve, 37, between the flaps, which extend out of the sleeve, and a reference side with an optical reference color 32 covered by a transparent window 31.

FIG. 6B shows the back side of the sleeve.

FIG. 6C shows cross section A-A through the optical reference side. The optical reference color 32 is covered by a flat rigid window 31 and is visible to the optical beam through window 33.

FIG. 6D is a cross section B-B through the pocket into which the QuantTab™ is inserted. 37 is the empty space for the inserting the QuantTab™ and 35 is the window through which the color is measured by the optics. FIG. 6E is cross section C-C through the sleeve showing the entrance 37 through which the detector is inserted into the sleeve.

FIG. 7A shows the QuantTab™ Detection Tab.

FIG. 7B shows the empty sleeve in which the QuantTab™ Detection Tab is inserted into.

FIG. 7C shows the QuantTab™ after it was inserted into the sleeve.

FIG. 8A shows a QuanTab™ formaldehyde detector with a protective tab 160 over the sample entry port. 120 is a laminated handle for ease of conducting the tests. The sample entry port 150 is available to the sample once the protective tab 160 is removed. Visible color forms in 130 to indicate detection.

FIG. 8B shows the entry port 150 as if it is covered with the peelable protective tab 160 which is removed before use and exposes the sample entry port.

FIG. 8C shows the protective tab.

FIG. 9A shows QuanTab™ Style #3 for accurate quantitative determination of formaldehyde in aqueous solutions. The detector includes two parts with identical construction: one side is used to react with the sample material and the other with water only. The entry port 250 is for letting sample in and the reference side includes port 260 for water. The color that develops on the sample side is measured through window 290 and the color formed on the reference side is viewed on window 280. 270 is a physical barrier that divides the two parts and prevents liquid from crossing from one side to the other.

FIG. 9B shows the back side of the detector.

FIG. 9C shows the cross section of the detector. The cross sections are identical for the sample and the water sides. The numbers in FIG. 9C correspond to the numbers in Table #1 as follows: 04 corresponds to the outer capsule, 60 corresponds to Layer #1, 70 corresponds to Layer #2, 80 corresponds to Layer #3 and 90 corresponds to Layer #4. 50 is a rigid non-permeable transparent window which allows viewing the color formed in 90.

The main uses of the various embodiments are as follows. The dipstick style detectors are used to detect or estimate semi-quantitatively the concentration of formaldehyde in solution. The solutions can be drinks, washing fluids, juices, run water, waste water, hospitals waste, funeral homes waste, etc. This type of detector is very low cost and can be used to screen suspect fluids for formaldehyde. If formaldehyde is found, one can use the QuantTab™ detectors to determine accurately the formaldehyde concentration.

The swab formaldehyde detectors are used to determine quickly if a solid has formaldehyde on its surface. The swabs are used on materials such as fish, shrimp, cheese, etc. provided that liquid can be absorbed from their surface.

The QuantTab™ detectors can be used to estimate the formaldehyde concentration by obtaining a reading electronically or by visual color comparison.

### DETAILED DESCRIPTION OF THE INVENTION

This invention describes a dry-chemistry-based-detector for aldehydes and the methodology for making them using three alternative chemistries. The word formaldehyde is used to denote all aliphatic aldehydes. The use of two of the chemistries to detect and determine the presence of formaldehyde in solutions was disclosed in the literature. The adaptation of these methods for use in a dry-chemistry-based detector was not. One novel detection chemistry is disclosed which was never reported in any application. The detectors detect formaldehyde in solution or on the surface of wet solids such as fish, shrimp etc. Examples of embodiments which are qualitatively or quantitatively are described.

The detectors of this invention use a sequence of supports, impregnated or coated with thin layers of the appropriate reagents and polymers, that ultimately imitates the sequence of reactions of the reagents had they occurred in solution. The detector is designed to act when wetted with an aqueous solution as if known amounts of reagents at the right ratios were added to the solution in a specific sequence and when specific time was allotted for the reactions to proceed to completion between the additions. The reagents may be in the form of thin layers, nano layers or coated particles or micro-encapsulated particles embedded in a polymeric barrier layer. The polymeric matrix or capsules act as barrier between the reagents when dry, but once the aqueous test solution dissolves the polymers, the reagents can react with each other and with the formaldehyde in the solution. The analytical process of this invention uses a single detection tab comprised of layers with many reagents, laminated together, to provide the same analytical result as if the operator used a sequence of additions of multiple reagents, dilution and other steps. Some of the options for implementing this technology are described in Table #1.

An objective of the present invention is to reduce the number of steps that the user has to take to detect formaldehyde to a single step. Many of the steps of the analytical procedures are combined into the detection tab, and take place automatically once the detector is wetted and the polymeric barriers are dissolved by the aqueous test solution.

Another objective of the present invention is to eliminate the need for the user to prepare calibration solutions and standards, mix them at the proper ratios and do multiple wet chemistry operations to accomplish the test.

Another objective of the present invention is to eliminate the need for skilled operators to determine if there is formaldehyde in a sample.

Another objective of the present invention is to eliminate the need for an instrumental laboratory to determine if there is formaldehyde in a sample.

Another objective of the present invention is to allow the operator to determine in few minutes even in the field if there is formaldehyde in a sample.

Another objective of the present invention is to provide a very low cost method for determining if there is formaldehyde in a sample so that it will be affordable even to private consumers.

Another objective of the present invention is to reduce the number of steps that the user has to take to detect an analyte in the surface of a moist solid to a single step. The surface of the solid may be contacted first by a swab-type detector and a few droplets of water are then added to the opening port in the detection tab. The water is allowed to permeate into the detector and color forms on the other side upon positive detection.

Another objective of the present invention is to provide encapsulated layered dry-chemistry based detector that keeps the layers in the same relative position to each other and to the sample entry ports so that the results will be reproducible quantitatively and qualitatively.

Another objective of the present invention is to provide encapsulated layered dry-chemistry based detector that keep the layers in the same position relative to each other and to viewing windows so that it will be possible to quantify the results using electronic means.

Another objective of this invention is to provide a detector which can give a semi-quantitative and/or a quantitative assessment of the formaldehyde concentration in the sample by comparing the color formed to a color chart which can either be printed on the storage envelope, on the detection card itself or on the test sleeve into which the card is inserted and then inserted into an electronic reader.

Another objective of this invention is to provide an instant quantitative detector for formaldehyde that can be utilized with an electronic reader.

Another objective of this invention is to facilitate the quantification of the color formed by providing with the detector a printed reference color that the electronic detector can use to better quantify the amount of formaldehyde in the sample.

Another objective of this invention is to provide a detector with two zones with the same chromophoric layers inside them. When conducting a test, the color of one zone is used to analyze the sample and the other is used as a reference.

The use of the principles of this invention is demonstrated via examples, where a solution of the sample is placed on a bibulous material and where a chromogenic reaction occurs with the analyte to indicate qualitatively, and/or quantitatively, the presence of formaldehyde. This is accomplished by a color change.

### Example #1A

### Dip Stick with Chemistry #1 Potassium Persulfate and KOH

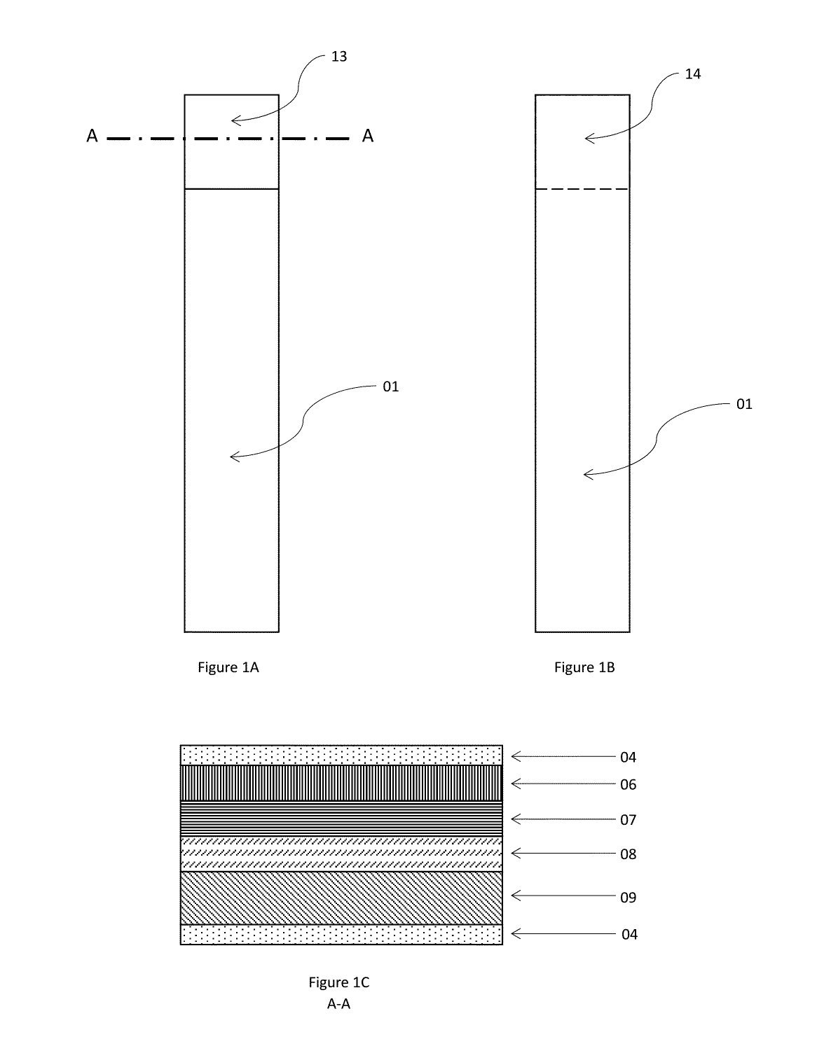

The design used in this example is depicted in FIG. 1A. The sample enters the detector through the edges of the detector and color forms on the back flat part of the detector. (FIG. 1B). Layer #04 is a polyester film with a thickness of 250 mills with 5 mills low density polyethylene coated on it. Layer #09 is bibulous porous paper with a porosity of 0.37 and thickness of 340 microns. Layer #08 is dipped in a suspension of microencapsulated potassium hydroxide in polyvinyl alcohol, with molecular weight of 10,000, PVA. The ratio of PVA to KOH is 11:1 with water as the solvent. Layer #07 is bibulous porous paper with a porosity of 0.37 and thickness of 180 microns. This layer is dipped in a solution of K₂S₂O₈ 200 mg/10 ml water. Layer #06 is a bibulous porous paper with a porosity of 0.37 and thickness of 180 microns coated by a solution of 20 mg 4-Amino-3-hydrazino-5-mercapto-1,2,4-triazole, 1 mg BHT and 1 gm. PVP in 10 ml water with rod No. 14 at speed of 5.08 cm/second.

### Example #1B

### Dip Stick with Chemistry #1 Potassium Persulfate and NaOH

This example is similar to Example #1 except that in layer #08 NaOH is used instead of KOH and the ratio to the PVA is 8.6:1.

### Example #1C

### Dip Stick with Chemistry #2 Potassium Persulfate and KOH

This example is similar to Example #1 except that ZnSO₄ is added to layer #06 at a ratio of 2.5:1 to the 4-Amino-3-hydrazino-5-mercapto-1,2,4-triazole.

### Example #1D

### Dip Stick with Chemistry #1 Sodium Periodate and KOH

The design used in this example is depicted in FIG. 1A. The sample enters the detector through the edges and color forms on the back flat part of the detector. (FIG. 1B). Layer #04 is a polyester film with a thickness of 250 mills with 5 mills low density polyethylene coated on it. Layer #09 is bibulous porous paper with a porosity of 0.37 and thickness of 340 microns. Layer 08 is dipped in a suspension of microencapsulated potassium hydroxide in polyvinyl alcohol, with molecular weight of 10,000. The ratio of PVA to KOH is 11:1 with water as the solvent. Layer #07 is bibulous porous paper with a porosity of 0.37 and thickness of 180 microns. This layer is dipped in a solution of NaIO₄ 200 mg/10 ml water. Layer #06 is a bibulous porous paper with a porosity of 0.37 and thickness of 180 microns coated with a solution of 20 mg 4-Amino-3-hydrazino-5-mercapto-1,2,4-triazole, 1 mg BHT and 1 gm. PVP in 10 ml water using rod No. 14 at speed of 5.08 cm/second.

### Example #1E

### Dip Stick with Chemistry #1 Potassium Periodate and NaOH

This example is similar to Example #1 except that NaOH is used instead of KOH and the ratio to the PVA is 8.6:1.

### Example #1F

### Dip Stick With Chemistry #2 Potassium Periodate and KOH

This example is similar to Example #1 except that ZnSO₄ is added to layer #06 at a ratio of 2.5:1 to the 4-Amino-3-hydrazino-5-mercapto-1,2,4-triazole.

### Example #1G

### Dip Stick with Chemistry #1 Zinc Nitrate and KOH

The design used in this example is depicted in FIG. 1A. The sample enters the detector through the sides and color forms on the back flat part of the detector. (FIG. 1B). Layer #04 is a polyester film with a thickness of 250 mills with 5 mills low density polyethylene coated on it. Layer #09 is bibulous porous paper with a porosity of 0.37 and thickness of 340 microns. Layer #08 is dipped in a suspension of microencapsulated potassium hydroxide in polyvinyl alcohol, with molecular weight of 10,000, PVA. The ratio of PVA to KOH is 11:1 with water as the solvent. Layer #07 is bibulous porous paper with a porosity of 0.37 and thickness of 180 microns. This layer is dipped in a solution of Zn(NO₃)₂ 200 mg/10 ml water. Layer #06 is a bibulous porous paper with a porosity of 0.37 and thickness of 180 microns coated by a solution of 20 mg 4-Amino-3-hydrazino-5-mercapto-1,2,4-triazole, 1 mg BHT and 1 gm. PVP in 10 ml water using rod No. 14 at speed of 5.08 cm/second.

### Example #1H

### Dip Stick with Chemistry #1 Zinc Nitrate and NaOH

This example is similar to Example #1 except that NaOH is used instead of KOH and the ratio to the PVA is 8.6:1.

### Example #1I

### Dip Stick with Chemistry #2 Zinc Nitrate and KOH

This example is similar to Example #1 except that ZnSO₄ is added to layer #06 at a ratio of 2.5:1 to the 4-Amino-3-hydrazino-5-mercapto-1,2,4-triazole,

### Example #1J

### Dip Stick with Chemistry #3 Potassium Ferricyanide

The design used in this example is depicted in FIG. 1A. The sample enters the detector through the edge and color forms on the back flat part of the detector. (FIG. 1B). Layer #04 is a polyester film with a thickness of 250 mills with 5 mills low density polyethylene coated on it. Layer #09 is bibulous porous paper with a porosity of 0.37 and thickness of 340 microns. Layer #08 is dipped in aqueous solution of 100 mg/10 ml potassium ferricyanide in polyvinyl alcohol, with molecular weight of 20,000, PVA. The ratio of PVA to K₃(CN)₆ is 15:1. Layer #07 is bibulous porous paper with a porosity of 0.37 and thickness of 180 microns. This layer is dipped in a solution of K₃[Fe(CN)₆] 10 mg/10 ml water. Layer #06 is a bibulous porous paper with a porosity of 0.37 and thickness of 180 microns coated by a solution of 20 mg 3-methyl-2-benzothiazoline hydrazone, 3 mg BHT and 0.7 gm. PVP in 10 ml water with rod No. 14 at speed of 5.08 cm/second. Turquoise-Blue color forms in both layers #07 and #06 when formaldehyde is detected. This color is visible from the back side of the detector through the transparent laminate.

### Example #2A

### QuantTab™ Style #1 Detector for Formaldehyde with Chemistry #1 Potassium Persulfate and KOH

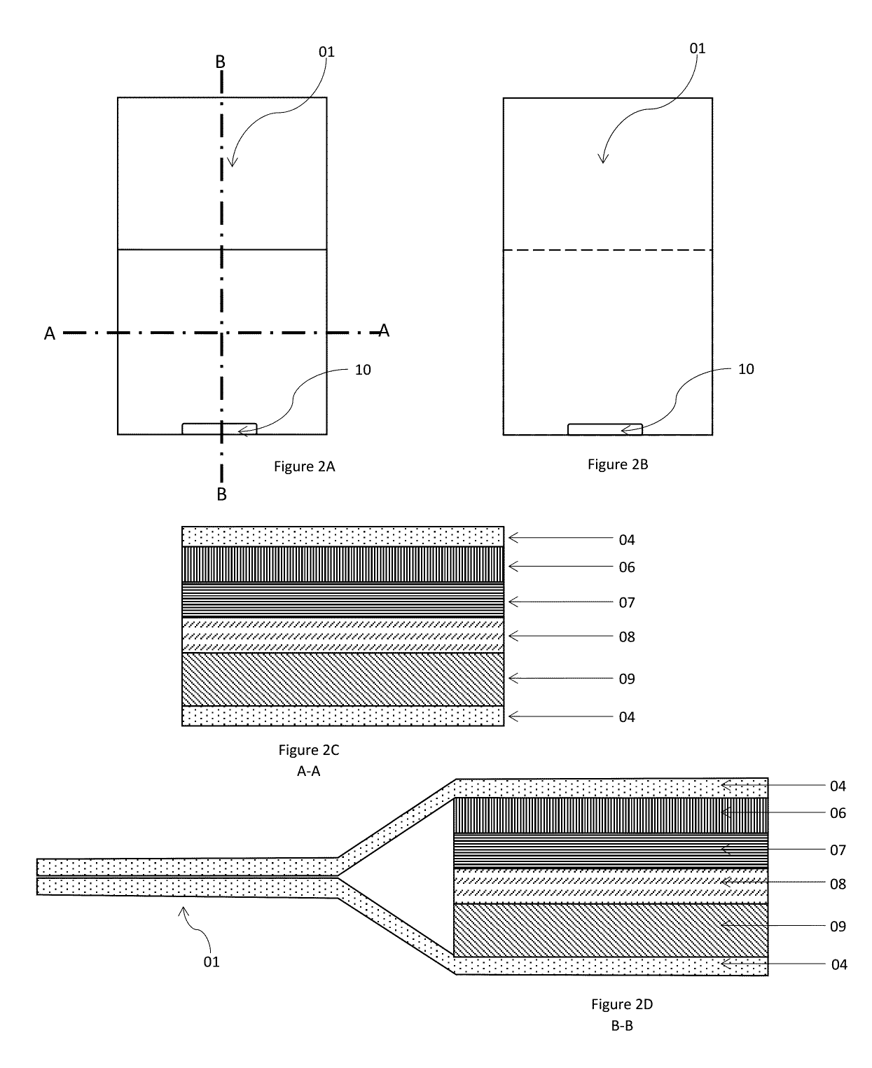

The design used in this example is depicted in FIG. 2A. The sample enters the detector through the bottom and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer #08 is dipped in a suspension of microencapsulated potassium hydroxide in polyvinyl alcohol, with molecular weight of 10,000, PVA. The ratio of PVA to KOH is 11:1 with water as the solvent. Layer #07 is bibulous porous paper with a porosity of 0.37 and thickness of 180 microns. This layer is dipped in a solution of K₂S₂O₈ 200 mg/10 ml water. Layer #06 is a bibulous porous paper with a porosity of 0.37 and thickness of 180 microns coated by a solution of 20 mg 4-Amino-3-hydrazino-5-mercapto-1,2,4-triazole, 1 mg BHT and 1 gm. PVP in 10 ml water using rod No. 14 at speed of 5.08 cm/second.

### Example #2B

### QuantTab™ Style #1 Detector for Formaldehyde with Chemistry #1 Sodium Periodate and KOH

The design used in this example is depicted in FIG. 2A. The sample enters the detector through the bottom port 10 and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer #08 is dipped in a suspension of microencapsulated potassium hydroxide in polyvinyl alcohol, with molecular weight of 10,000. The ratio of PVA to KOH is 11:1 with water as the solvent. Layer #07 is bibulous porous paper with a porosity of 0.37 and thickness of 180 microns. This layer is dipped in a solution of NaIO₄ 200 mg/10 ml water. Layer #06 is a bibulous porous paper with a porosity of 0.37 and thickness of 180 microns coated by a solution of 20 mg 4-Amino-3-hydrazino-5-mercapto-1,2,4-triazole, 1 mg BHT and 1 gm. PVP in 10 ml water using rod No. 14 at speed of 5.08 cm/second.

### Example #2C

### QuantTab™ Style #1 Detector for Formaldehyde with Chemistry #1 Nitric Acid and KOH

The design used in this example is depicted in FIG. 2A. The sample enters the detector through sample entry port 10 in the bottom and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer 08 is dipped in a suspension of microencapsulated potassium hydroxide in polyvinyl alcohol, with molecular weight of 10,000. The ratio of PVA to KOH is 1 1:1 with water as the solvent. Layer #07 is bibulous porous paper with a porosity of 0.37 and thickness of 180 microns. This layer is dipped in a 1 N nitric acid solution. Layer #06 is a bibulous porous paper with a porosity of 0.37 and thickness of 180 microns coated by a solution of 20 mg 4-Amino-3-hydrazino-5-mercapto-1,2,4-triazole, 2 mg BHT and 1 gm. PVP in 10 ml water using rod No. 14 at speed of 5.08 cm/second.

### Example #2D

### QuantTab™ Style #1 Detector for Formaldehyde with Chemistry #1 Potassium Nitrate and KOH

The design used in this example is depicted in FIG. 2A. The sample enters the detector through the sample entry port 10 in the bottom and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer 08 is dipped in a suspension of microencapsulated potassium hydroxide in polyvinyl alcohol, with molecular weight of 10,000, PVA. The ratio of PVA to KOH is 11:1 with water as the solvent. Layer #07 is bibulous porous paper with a porosity of 0.37 and thickness of 180 microns. This layer is dipped in a solution of KNO₃ 200 mg/10 ml water. Layer #06 is a bibulous porous paper with a porosity of 0.37 and thickness of 180 microns coated by a solution of 20 mg 4-Amino-3-hydrazino-5-mercapto-1,2,4-triazole, 1 mg BHT and 1 gm. PVP in 10 ml water using rod No. 14 at speed of 5.08 cm/second.

### Example #2E

### QuantTab™ Style #1 Detector for Formaldehyde with Chemistry #2 Zinc Nitrate and KOH

The design used in this example is depicted in FIG. 2A. The sample enters the detector through the sample entry port 10 in the bottom and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer #08 is dipped in a suspension of microencapsulated potassium hydroxide in polyvinyl alcohol, with molecular weight of 10,000, PVA. The ratio of PVA to KOH is 11:1 with water as the solvent. Layer #07 is bibulous porous paper with a porosity of 0.37 and thickness of 180 microns. This layer is dipped in a solution of Zn(NO₃)₂ 200 mg/10 ml water. Layer 06 is a bibulous porous paper with a porosity of 0.37 and thickness of 180 microns coated by a solution of 20 mg 4-Amino-3-hydrazino-5-mercapto-1,2,4-triazole, 2 mg BHT 50 mg ZnSO₄.7H₂O and 1 gm. PVP in 10 ml water using rod No. 14 at speed of 5.08 cm/second.

### Example #2F

### QuantTab™ Style #1 Detector for Formaldehyde with Chemistry #3 and Sodium Periodate

The design used in this example is depicted in FIG. 2A. The sample enters the detector through the bottom and color forms on the back flat part of the detector. (FIG. 2B). Layer #04 is a polyester film with a thickness of 250 mills with 5 mills low density polyethylene coated on it. Layer #09 is bibulous porous paper with a porosity of 0.37 and thickness of 180 microns. Layer #08 is dipped in a solution of ammonium ferric sulfate 200 mg/10 ml containing 0.5 gm. polyvinyl alcohol, with molecular weight of 10,000, PVA The ratio of PVA to ammonium ferric sulfate is 5:2 with water as the solvent. Layer #07 is bibulous porous paper with a porosity of 0.37 and thickness of 180 microns. This layer is dipped in a solution of KIO₄ 20 mg/10 ml water. Layer #06 is a bibulous porous paper with a porosity of 0.37 and thickness of 180 microns coated by a solution of 20 mg MBTH, 2 mg BHT and 1 gm. PVP in 10 ml water using rod No. 14 at speed of 5.08 cm/second.

### Example #3A

### QuantTab™ Style #2 Detector for Formaldehyde with Chemistry #1 Sodium Perchlorate and KOH

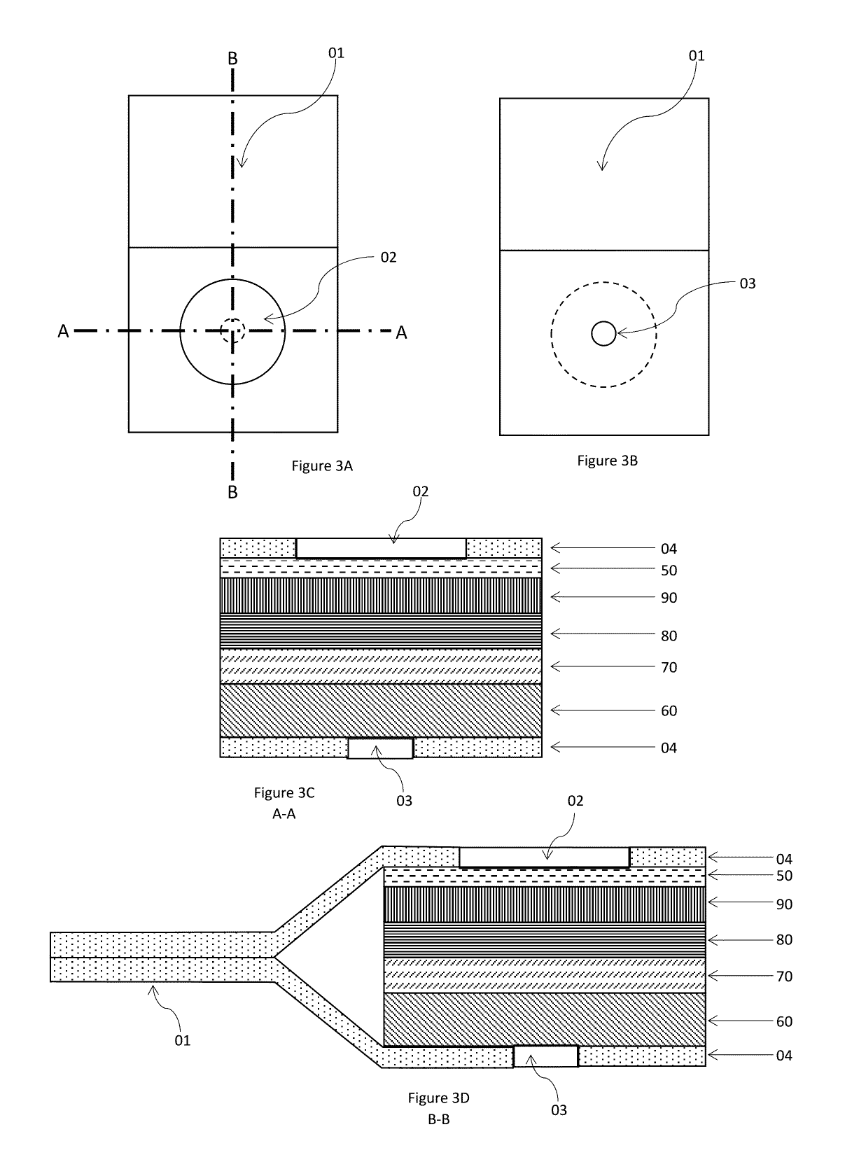

The design used in this example is depicted in FIG. 3A. The sample is introduced into the detector through a 5 mm Φhole in the polymeric film capsule from the back side, marked 03 in FIG. 3B. The sample percolates through several layers in the detector and forms color in layer 90 as shown in FIGS. 3C and 3D. Layer #50 in FIGS. 3C and 3D is made out of 200 mills transparent polycarbonate plate and is not permeable to the solution. Layer #50 provides a clear optical window to a light beam which is used to measure quantitatively the color formed. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000, PVA. The ratio of PVA to KOH is 11:1 with water as the solvent. Layer #80 is bibulous porous paper with a porosity of 0.37 and thickness of 180 microns. This layer is dipped in a solution of KClO₄ 200 mg/10 ml water. Layer #90 is a bibulous porous paper with a porosity of 0.37 and thickness of 180 microns coated by a solution of 20 mg 4-Amino-3-hydrazino-5-mercapto-1,2,4-triazole, 3 mg BHT and 1 gm. PVP in 10 ml water using rod No. 14 at speed of 5.08 cm/second.

### Example #3B

### QuantTab™ Style #2 Detector for Formaldehyde with Chemistry #1 Zinc Nitrate and KOH

The design used in this example is depicted in FIG. 3A. The sample is introduced into the detector through a 5 mm Φhole in the polymeric film capsule from the back side, marked 03 in FIG. 3B. The sample percolates through several layers in the detector and forms color in layer #90 as shown in FIGS. 3C and 3D. Layer #50 in FIGS. 3C and 3D is made out of 200 mills transparent polycarbonate plate and is not permeable to the solution. Layer 50 provides a clear optical window to a light beam which is used to measure quantitatively the color formed. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000, PVA. The ratio of PVA to KOH is 11:1 with water as the solvent. Layer #80 is bibulous porous paper with a porosity of 0.37 and thickness of 180 microns. This layer is dipped in a solution of Zn(NO₃)₂ 200 mg/10 ml water. Layer #90 is a bibulous porous paper with a porosity of 0.37 and thickness of 180 microns coated by a solution of 20 mg 4-Amino-3-hydrazino-5-mercapto-1,2,4-triazole, 3 mg BHT and 1 gm. PVP in 10 ml water using rod No. 14 at speed of 5.08 cm/second.

### Example #3C

### QuantTab™ Style #2 Detector for Formaldehyde with Chemistry #2 Zinc Nitrate and KOH

The design used in this example is depicted in FIG. 3A. The sample is introduced into the detector through a 5 mm Φhole in the polymeric film capsule from the back side, marked 03 in FIG. 3B. The sample percolates through several layers in the detector and forms color in Layer #90 as shown in FIGS. 3C and 3D. Layer #50 in FIGS. 3C and 3D is made out of 200 mills transparent polycarbonate plate and is not permeable to the solution. Layer #50 provides a clear optical window to a light beam which is used to measure quantitatively the color formed. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000, PVA. The ratio of PVA to KOH is 11:1 with water as the solvent. Layer #80 is bibulous porous paper with a porosity of 0.37 and thickness of 180 microns. This layer is dipped in a solution of Zn(NO₃)₂ 200 mg/10 ml water. Layer #90 is a bibulous porous paper with a porosity of 0.37 and thickness of 180 microns coated by a solution of 20 mg 4-Amino-3-hydrazino-5-mercapto-1,2,4-triazole, 3 mg BHT, 50 mg ZnSO₄.7H₂O and 1 gm. PVP in 10 ml water using rod No. 14 at speed of 5.08 cm/second.

### Example #3D

### QuantTab™ Style #2 Detector for Formaldehyde with Chemistry #3 Ammonium Ferric Sulfate and Sodium Perchlorate

The design used in this example is depicted in FIG. 3A. The sample is introduced into the detector through a 5 mm Φhole in the polymeric film capsule from the back side, marked 03 in FIG. 3B. The sample percolates through several layers in the detector and forms color in Layer #90 as shown in FIGS. 3C and 3D. Layer #50 in FIGS. 3C and 3D is made out of 120 mills transparent glass plate and is not permeable to the aqueous solution. Layer #50 provides a clear optical window to a light beam which is used to measure quantitatively the color formed in Layer #90. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a solution of ammonium ferric sulfate 200 mg/10 ml containing 0.5 gm. polyvinyl alcohol, with molecular weight of 10,000, PVA. The ratio of PVA to ammonium ferric sulfate is 5:2 with water as the solvent. Layer #80 is bibulous porous paper with a porosity of 0.37 and thickness of 180 microns. This layer is dipped in a solution of KClO₄ 200 mg/10 ml water. Layer #90 is a bibulous porous paper with a porosity of 0.37 and thickness of 180 microns coated by a solution of 20 mg MBTH 3 mg BHT and 1 gm. PVP in 10 ml water using rod No. 14 at speed of 5.08 cm/second.

### Example #4A

### Swab Detector for Formaldehyde with Chemistry #1 Zinc Nitrate and KOH

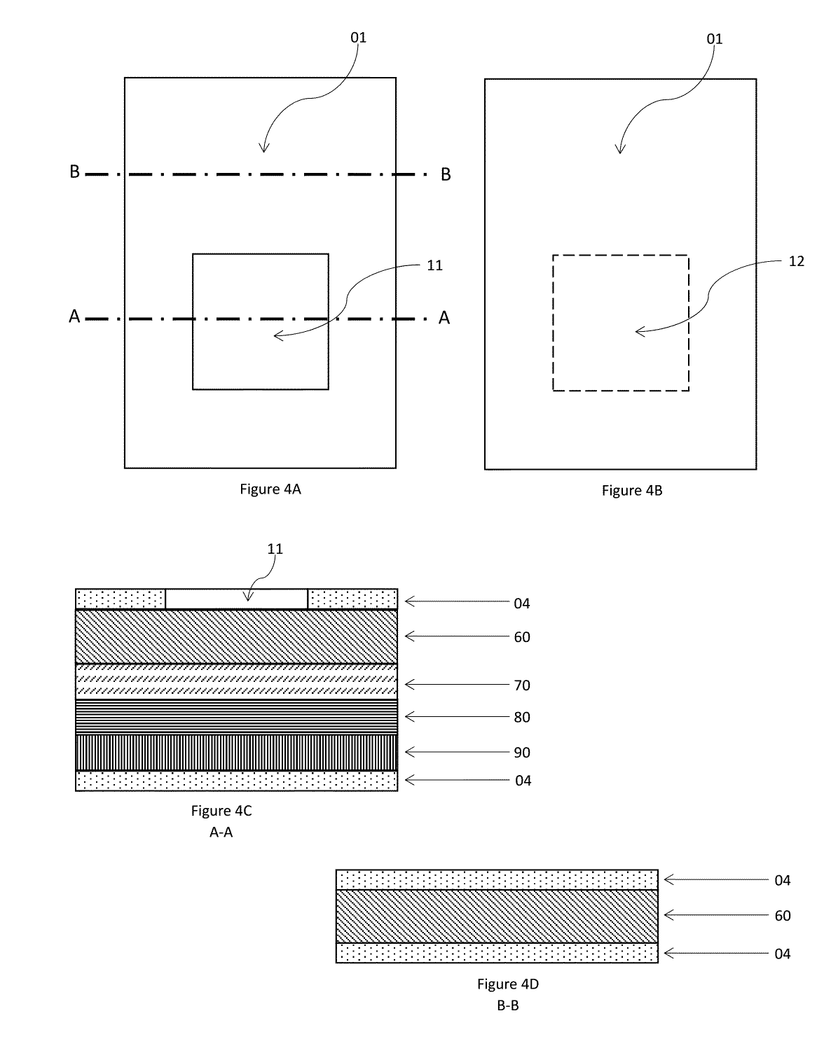

The design used in this example is depicted in FIG. 4A. The wet solid sample is swabbed to let the test solution enter the detector through opening 11 in FIG. 4A. The size of this square opening hole in the polymeric film capsule of the detector is 9.8×9.8 mm square. The sample permeates through several layers in the detector and forms color in Layer #50 as shown in FIG. 4C. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000. The ratio of PVA to KOH is 11:1 with water as the solvent. Layer #80 is bibulous porous paper with a porosity of 0.37 and thickness of 180 microns. This layer is dipped in a solution of Zn(NO₃)₂ 200 mg/I 0 ml water. Layer #90 is a bibulous porous paper with a porosity of 0.37 and thickness of 180 microns coated by a solution of 20 mg 4-Amino-3-hydrazino-5-mercapto-1,2,4-triazole, 3 mg BHT and 1 gm. PVP in 10 ml water using rod No. 14 at speed of 5.08 cm/second. Upon a positive detection, purple color forms in layer

### Example #4B

### Swab Detector for Formaldehyde with Chemistry #2 Zinc Nitrate and KOH and Zinc Sulfate

The design used in this example is depicted in FIG. 4A. The wet solid sample is swabbed to let the test solution enter the detector through opening 11 in FIG. 4A. The size of this square opening hole in the polymeric film capsule of the detector is 9.8×9.8 mm square. The sample permeates through several layers in the detector and forms color in Layer #90 as shown in FIG. 4C. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000. The ratio of PVA to KOH is 11:1 with water as the solvent. Layer #80 is bibulous porous paper with a porosity of 0.37 and thickness of 180 microns. This layer is dipped in a solution of Zn(NO₃)₂ 200 mg/10 ml water. Layer #90 is a bibulous porous paper with a porosity of 0.37 and thickness of 180 microns coated by a solution of 20 mg 4-Amino-3-hydrazino-5-mercapto-1,2,4-triazole, 50 mg ZnSO₄.7H₂O, 3 mg BHT and 1 gm. PVP in 10 ml water using rod No. 14 at speed of 5.08 cm/second. Upon a positive detection, purple-pink color forms in layer

### Example #4C

### Swab Detector for Formaldehyde with Chemistry #2 Cellulose Nitrate and KOH and Zinc Sulfate

The design used in this example is depicted in FIG. 4A. The wet solid sample is swabbed to let the test solution enter the detector through opening 11 in FIG. 4A. The size of this square opening hole in the polymeric film capsule of the detector is 9.8×9.8 mm square. The sample permeates through several layers in the detector and forms color in Layer #90 as shown in FIG. 4C. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a suspension of microencapsulated potassium hydroxide in polyvinyl alcohol, with molecular weight of 10,000, PVA. The ratio of PVA to KOH is 11:1 with water as the solvent. Layer #80 is bibulous porous paper with a porosity of 0.37 and thickness of 180 microns. This layer is dipped in a solution consisting of 50% iso-propyl alcohol 70%, and collodion. Layer #90 is a bibulous porous paper with a porosity of 0.37 and thickness of 180 microns coated by a solution of 20 mg 4-Amino-3-hydrazino-5-mercapto-1,2,4-triazole, 50 mg ZnSO₄.7H₂O, 3 mg BHT and 1 gm. PVP in 10 ml water using rod No. 14 at speed of 5.08 cm/second. Upon a positive detection, purple-pink color forms in layer

### Example #4D

### Swab Detector for Formaldehyde with Chemistry #3 Ferric Sulfate and Sodium Periodate

The design used in this example is depicted in FIG. 4A. The wet solid sample is swabbed to let the test solution enter the detector through opening 11 in FIG. 4A. The size of this square opening hole in the polymeric film capsule of the detector is 9.8×9.8 mm square. The sample permeates through several layers in the detector and forms color in Layer #90 as shown in FIG. 4C. Layer #04 is a polyester film with a thickness of 250 mills with 5 mills low density polyethylene coated on it. This layer encapsulates the inner layers of the detector and keeps the ports and viewing windows in the proper orientation relative to each other. Layer #60 is bibulous porous paper with a porosity of 0.37 and thickness of 180 microns. Layer #70 is bibulous paper with thickness of 180 microns and porosity of 0.37 dipped in a solution of ammonium ferric sulfate 200 mg/10 ml containing 0.5 gm. polyvinyl alcohol, with molecular weight of 10,000, PVA. The ratio of PVA to ammonium ferric sulfate is 5:2 with water as the solvent. Layer #80 is bibulous porous paper with a porosity of 0.37 and thickness of 180 microns. This layer is dipped in a solution of KNO₃ 200 mg/10 ml water. Layer #90 is a bibulous porous paper with a porosity of 0.37 and thickness of 180 microns coated by a solution of 20 mg MBTH, 3 mg BHT and 1 gm. PVP in 10 ml water using rod No. 14 at speed of 5.08 cm/second. Upon a positive detection, turquoise color forms in Layer #90.

### Example #5

### Storage Envelope

One or more detectors can be stored in a single sealed envelope. The envelope is made out of aluminum foil with polyethylene film acting as an adhesive in lamination. A small notch may be made on the envelope to facilitate opening it to retrieve the detectors in it. A label with a reference color chart can be adhered onto is printed on the storage envelope to allow comparing the color formed on the detector with specific formaldehyde concentrations. Other materials may be used to make the storage envelope including but not limited to plastic or metallic films, metalized polymeric film, coated paper, metallic films with an adhesive polymer, etc.

### Example 6

### Detector with Printed Reference Color for Visual Color Comparison

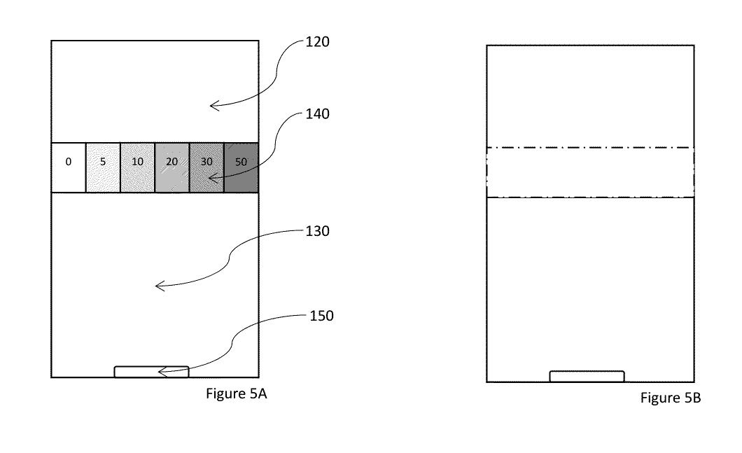

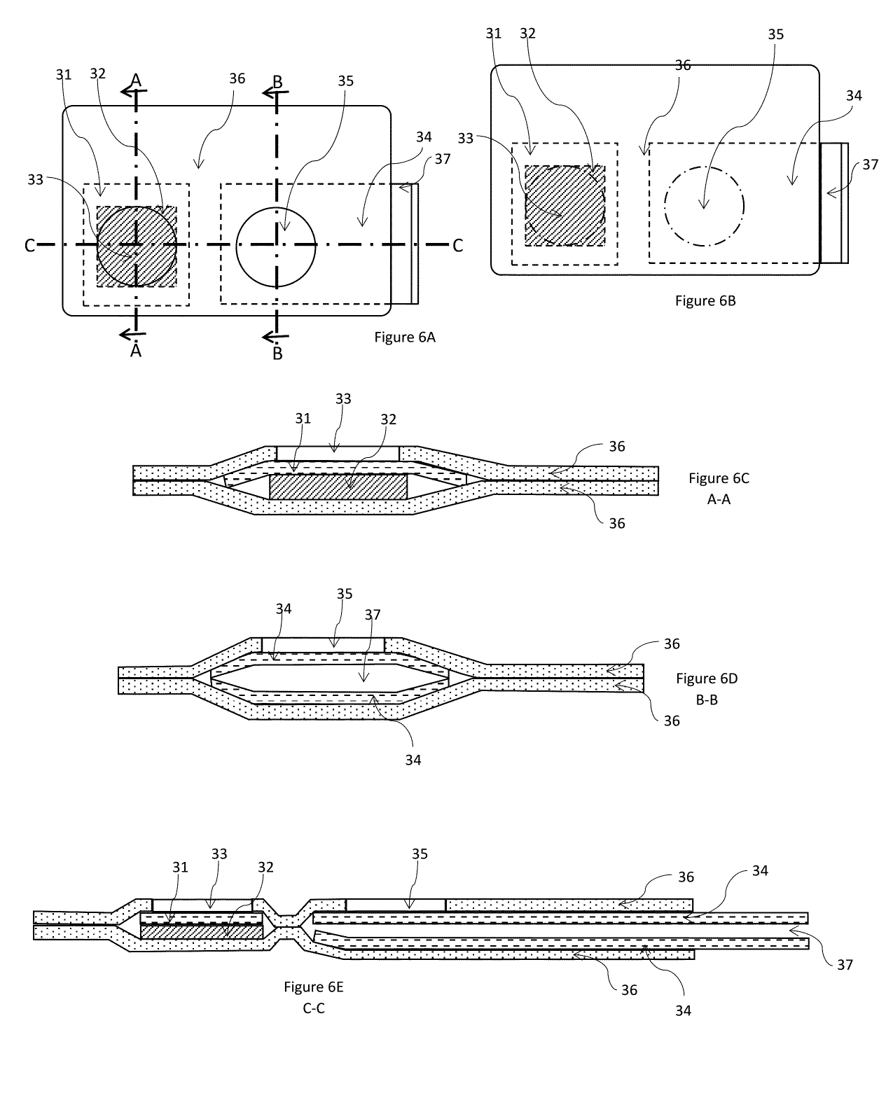

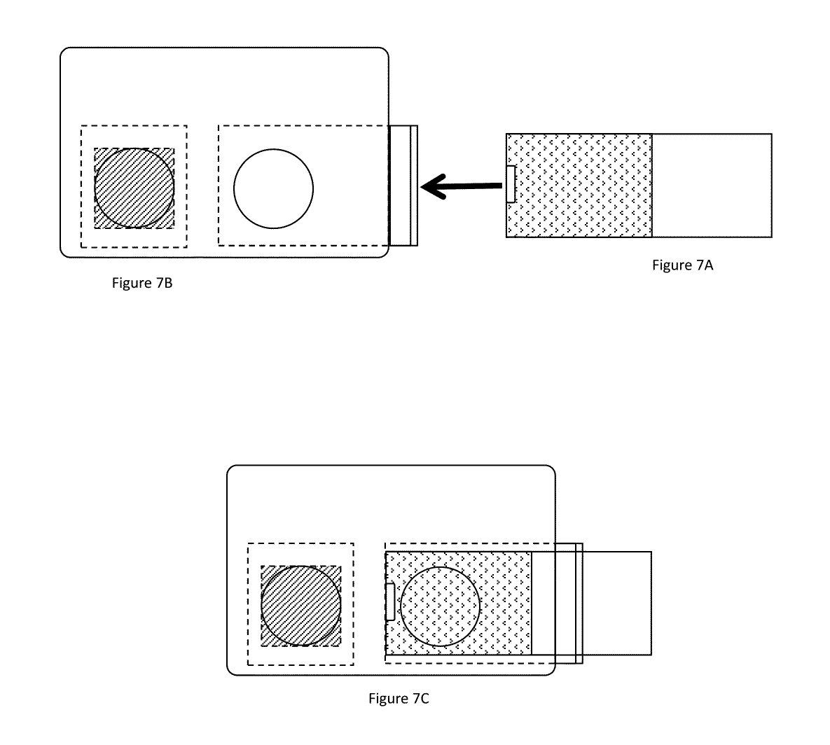

FIG. 5A shows the front of a QuantTab™ laminated detection tab for quantitative determination of formaldehyde Style 3 with the sample introduction port 150 on the bottom edge of the card. FIG. 5B shows the back side of the detection card. This card was designed for visual quantification by matching the color formed to a printed color chart. The color chart and the identification information are printed on a label or on the detector itself. Various options may be used to depict the color chart and/or the information on the detector. The particular form in the picture is only for illustration purposes.

### Example 7

### QuantTab™ Style #3 Detector for Quantitative Determination of Formaldehyde

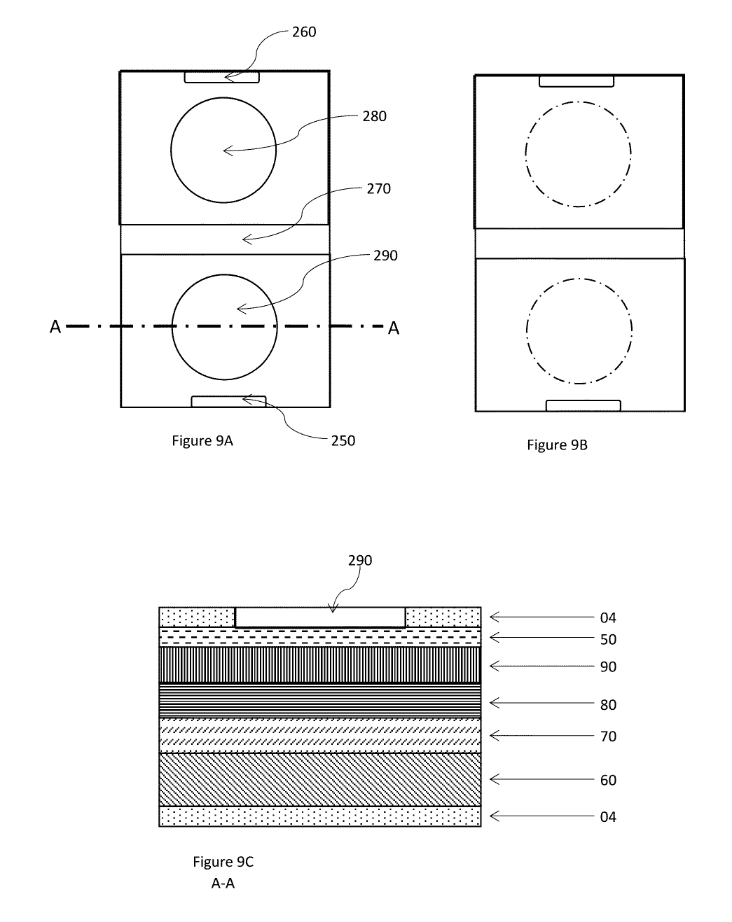

FIG. 9A shows the front of a QuantTab™ laminated detection tab for quantitative determination of formaldehyde Style 3. This QuantTab™ has two distinct parts: A sample side and a reference side. The sample is introduced through port 250 on the bottom edge of the card. Water is introduced through port 260. Both the sample and the water are allowed to permeate simultaneously through the detector. Any of the chemistries described previously may be used in this detector. The example shows the use of chemistry 2. The optical reader measures the color formed in window 290 and the reference color formed in window 280 and use both measurements to estimate the net color formed due to formaldehyde. Window 280 provides an optical reference for the electronic reader. This card was designed for color quantification using an electronic reader which reads the color on two places on the laminated detector: A reference site and a site which color changed due to the detection process. The electronic reader views both windows and evaluates the exposure using the color of both of them.

### Example 8

### A Laminated Detector with the Sample Entry Port Covered with a Removable Tape During Storage

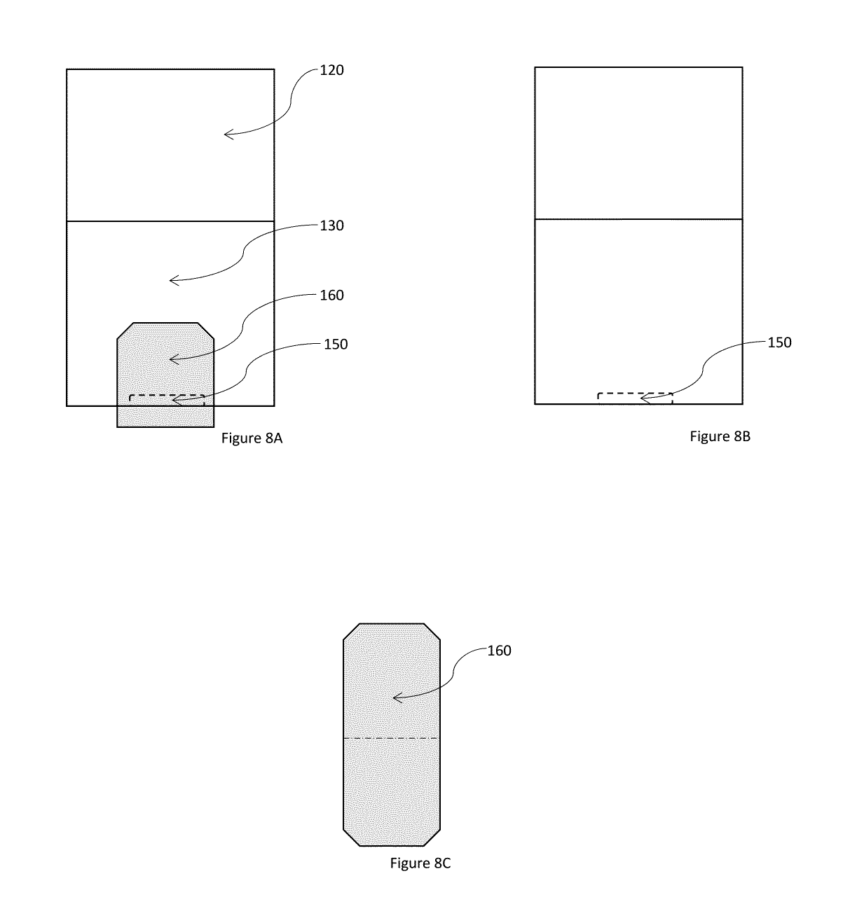

FIG. 8A shows a laminated detection tab with a protective tape and FIG. 8B shows the laminated detection tab, right before use when the protection tab is removed. The protected detection tab may be stored in a sealed storage envelope for extra protection.

It is to be understood that the invention is not limited to the illustrations described herein, which are deemed to illustrate a typical form of carrying out the invention. From the foregoing description, one skilled in the art can readily ascertain the essential characteristics of this invention and make various changes and modifications of the invention to adapt it to various usages and conditions without departing from the spirit and scope as defined by the claims.

What is claimed is:

1. A sensitive reagent for the detection of aldehydes comprised of 4-amino-3-hydrazino-5-mercapto-1,2,4-triazole and a divalent, trivalent, or quadrivalent metal ion.

2. The reagent of claim 1 where the metal ion is selected from the group of bismuth, aluminum, chromium, cadmium, thallium, copper, cobalt, nickel, lead, mercury, lanthanum, zinc, calcium, barium, strontium, titanium, hafnium, zirconium, cerium, vanadium, iron, manganese, tin, molybdenum and tungsten.

3. A detector consisting of multiple layers of bibulous material containing reagents tailored to detect aldehyde comprising:
A. an efficacy layer,
B. an oxidizing layer.
C. a reagent layer containing a hydrazine-based chromogene, and,
D. an encapsulating envelope that:
a. keeps all the layers together,
b. facilitates the introduction of an aqueous sample into the detector from specific locations, entry ports, so that the liquid will wet the various layers in a specific pattern and order. and,
c. help keep the locations that color is formed in specific locations relative to the edges of the detector to facilitate visual and electronic color comparison and quantification.

4. A detector of claim 3 where the bibulous material is selected from the group of paper, cotton, polymeric materials including polyethylene, polypropylene, polyvinyl chloride, polystyrene, metal particles including aluminum and stainless steel.

5. A detector of claim 3 where the oxidizing layer is comprised of an oxidizing material coated onto, encapsulated in or embedded within a polymer on the bibulous material of the layer.

6. A detector of claim 5 where the oxidizing material is selected from the group of perchlorates, perbromates, periodates, chlorates, bromates, iodates, persulphates, nitrates such as potassium nitrate, sodium nitrate, zinc nitrate, lanthanum nitrate, lead nitrate, etc. peroxy-carbonate such as sodium peroxy carbonate, potassium peroxy carbonate, etc., organic nitro compounds such as nitrocellulose, picric, collodion, acid, organic peroxides such as dibenzyl peroxide, di tert butyl peroxide, etc., organic hydroperoxides such as butyl hydroperoxide, tetralyl hydroperoxide, etc.

7. A detector of claim 3 where the efficacy layer is comprised of a base coated onto, encapsulated in, or embedded within a polymer and onto, the bibulous material of the efficacy layer and the reagent layer is comprised of 4-amino-3-hydrazino-5-mercapto-1,2,4-triazole coated onto, encapsulated in, or embedded on a polymer of the bibulous material of the reagent layer.

8. A detector of claim 7 where the base is selected from the group of sodium hydroxide, potassium hydroxide, lithium hydroxide, calcium hydroxide, barium hydroxide, strontium hydroxide, lithium hydroxide and organic alkyl quaternary ammonium hydroxide.

9. A detector of claim 8 where the polymer used to encapsulate the base is a single polymer or a blend of several polymers taken out of the group of poly(vinyl pyrilidone), polyalkylmethacrylate, poly(ethylene oxide), poly(vinyl alcohol), polyethylene glycol, poly(2-ethyl-2-oxazoline), and poly(sodium 4-styrene-sulfonate).

10. A detector of claim 7 where the base is comprised of a solvent coated onto, encapsulated in, or embedded on a polymer onto, the bibulous material of the layer, where the solvent has a boiling point greater than 140° C. and contains hydroxyl or amine groups.

11. A detector of claim 10 where the solvent is selected from the group of alkyl hydroxylated ethers, amines such as partially methylated or ethylated glycerin, partially methylated or ethylated esters of polyhydroxy aliphatic acids such as 3,4-dihydroxy-methyl-buterate, etc.

12. A detector of claim 7 where the polymer in the reagent layer is selected from the group of poly(vinyl alcohol), poly(ethylene glycol), poly methyl methacrylate, poly(vinyl pyrilidone), or blends thereof, or co-polymers of water-soluble polymers including polyalkylmethacrylate, poly(ethylene oxide), poly(2-ethyl-2-oxazoline), and poly(sodium 4-styrene-sulfonate

13. A detector of claim 3 where the efficacy layer is comprised of a base coated onto, encapsulated in, or embedded in a polymer, and onto the bibulous material of the efficacy layer and the reagent layer is comprised of 4-amino-3-hydrazino-5-mercapto-1,2,4-triazole and a divalent, trivalent, or quadrivalent metal ion coated onto, encapsulated in, or embedded on a polymer of the bibulous material of the reagent layer.

14. A detector of claim 13 where the base is selected from the group of sodium hydroxide, potassium hydroxide, lithium hydroxide, calcium hydroxide, barium hydroxide, strontium hydroxide, lithium hydroxide and organic alkyl quaternary ammonium hydroxide.

15. A detector of claim 14 where the polymer used to encapsulate the base is a single polymer or a blend of several polymers taken out of the group of polyvinyl pyrilidone, polyalkylmethacrylate, polyethylene oxide, polyvinyl alcohol, polyethylene glycol and alkylated cellulose.

16. A detector of claim 13 where a solvent with a boiling point greater than 140° C. and contains hydroxyl or amine groups is used instead of or in addition to the polymer.

17. A detector of claim 16 where the solvent is selected from the group of alkyl hydroxylated ethers, amines such as partially methylated or ethylated glycerin, partially methylated or ethylated esters of polyhydroxy aliphatic acids such as 3,4-dihydroxy-methyl-buterate, etc.

18. A detector of claim 13 where the polymer in the reagent layer is selected from the group of polyvinyl alcohol, poly ethylene glycol, poly methyl methacrylate, poly vinyl pyrilidone, or blends thereof, or co-polymers of water-soluble polymers.

19. A detector of claim 3 where the efficacy layer is comprised of a catalyst or oxidizer in a matrix coated, encapsulated in, or embedded in a polymer or in a solvent and onto the bibulous material and the reagent layer is comprised of a polymer and 3-methyl-2-benzothiazolinone hydrazine coated onto, encapsulated in or embedded in a polymer on the bibulous material of the layer.

20. A detector of claim 19 where the matrix holding the catalyst or oxidizer is a solvent and it is coated onto, encapsulated in, or embedded on a polymer onto, the bibulous material of the efficacy layer, where the solvent has a boiling point greater than 140° C. and contains hydroxyl of amine groups.

21. A detector of claim 20 where the solvent is selected from the group of alkyl hydroxylated ethers, amines such as partially methylated or ethylated glycerin, partially methylated or ethylated esters of polyhydroxy aliphatic acids such as 3,4 dihydroxy methyl buterate, etc.

22. A detector of claim 19 where the polymer in the reagent layer is selected from the group of polyvinyl alcohol, poly ethylene glycol, poly methyl methacrylate, poly vinyl pyrilidone, or blends thereof, or co-polymers of water-soluble polymers.

23. A detector of claim 3 further comprising an additional layer of untreated bibulous material.

24. A detector of claim 3 where the encapsulating polymeric film is made of two or more distinct materials.

25. A detector of claim 24 where at least one layer of the encapsulating polymeric film is transparent.

26. A detector of claim 24 where the encapsulating polymeric film is made out of one or more materials selected from the group of polyester, polyethylene, polypropylene, polycarbonate, polymethylmethacrylate, paper, coated paper and aluminum foil.

27. A detector of claim 3 where the sample is introduced through one or more holes on the flat edge of the detector opposite the side with the reagent layer and said hole or holes are lined with a porous permeable material which allows sample material and water to enter the inside of the detector.

28. A detector of claim 3 where the sample is introduced through one or more holes on the detector and said hole or holes are lined with a porous permeable material which allows sample material and water to enter the inside of the detector.

29. A detector of claim 28 where the porous permeable material is selected from the group of paper, cloth, polymeric membranes including Nylon, cellulose nitrate, cellulose esters including acetate, poly fluoro polymers including polytetrafluoro ethylene, polyvinylfluoride, polyvinyl acetate, cellulose acetate, nitrocellulose, cellulose esters, polysulfone, polyether sulfone, polyacrilonitrile, polyamide, polyimide, polyethylene, polypropylene, polyvinylidene fluoride, polyvinylchloride, ceramic material or a porous metallic layer.

30. A detector of claim 3 where the sample entry ports are located:
i. on the side of the detector opposite to the side containing the chromogene,
ii. on the narrow edge of detector,
ii. on the wide edge of the detector.

31. A detector of claim 3 where the encapsulating polymeric film has holes designed to allow viewing the color formed due to the detection of aldehydes and measuring the color formed by visual color comparison or electronic means.

32. A detector of claim 31 where the holes designed to allow viewing the color formed are on the side of the encapsulating polymeric film adjacent to the chromogene layer.

33. A detector of claim 32 where the holes designed to allow viewing the color formed are covered by a rigid plate made out of a transparent material selected from the group including glass, silica, polycarbonate, and polymethylmethacrylate or other transparent polymeric films.

34. A detector of claim 3 where the encapsulating polymeric film extends beyond the reagent layers to provide a handle to hold the detector, an area to print or adhere a label or a printed reference color that provides a reference for visual color comparison or a reference for color comparison by an optical reader.

35. A detector of claim 34 where the reference for color comparison can be used by an optical reader.

36. A detector of claim 3 where the detector is stored within envelopes made of a material impervious to gases, light, UV and humidity to protect the detector from deterioration and where the envelope may also contain materials or capsules which absorb oxygen, humidity, carbon dioxide and other gases.

37. A detector of claim 36 where the envelope has additional information displayed on its surface to indicate the user name, the manufacturing lot number, as well as room for user added information such as date of test, location, sample type etc.

38. The detector of claim 37 where additional sensors are included on it to indicate additional variables such as the age of the detector, its residual shelf life, the relative humidity, the sample pH, the presence of potentially-interfering materials, etc.

39. A detector of claim 3 where the detector is used with a sleeve that facilitates insertion of the detector into an optical reader.

40. A detector of claim 39 where the sleeve includes a printed reference to provide a color reference for reading within an optical reader.

41. A detector of claim 3 that allows for viewing the color response of two detection sites separately where the multiple layers of bibulous material are separated into two or more isolated compartments between which liquid communication is not possible and where each is equipped with a separate hole for introduction of the sample and a separate hole for viewing the color formed.

42. A detector of claim 41 where the color developed in one or more of the isolated compartments is measurable by visual color comparison or by electronic means for quality control or quantitative assessment of the concentration of the aldehyde.

43. A detector of claim 42 where one of the isolated compartments can be exposed to a reference sample and the other isolated compartment can be exposed to another sample for analysis.
